(19) United States
(12) Patent Application Publication
(10) Pub. No.: US 2010/0313748 A1
(43) Pub. Date: Dec. 16, 2010

(54) Method and system for smart air filter monitoring

(75) Inventor: Robert Schluter, Kinnelon, NJ (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: Middle Atlantic Products, Inc.

(21) Appl. No.: 12/456,402

(22) Filed: Jun. 15, 2009

(51) Int. Cl. B01D 46/46; B01D 46/00

(52) U.S. Cl. 95/25; 96/417; 96/399; 55/511; 96/418; 96/397

(57) ABSTRACT

In one aspect of the invention a smart air filter monitoring system for a cabinet for electronic devices is provided that includes: an air filter positioned in an air flow so that substantially all the air flows through the filter, the air flow being defined by the cabinet; a light emitting device on a first side of the air filter; at least two light sensors mounted near the air filter, each light sensor directed to the air filter to receive light emitted from the light emitting device after the emitted light has passed through the air filter, the light sensors adapted to generate electrical signals from the emitted light striking the light sensor; an electrical circuit, the electrical circuit generating a signal for indicating that the filter needs to be serviced when the electrical circuit determines that electrical signals received from a combination of the sensors indicates that the filter needs to be serviced.

### FIELD OF THE INVENTION

This invention pertains generally to filtration systems. More particularly, the present invention pertains to smart air filter monitoring methods and system for rack cabinets.

### BACKGROUND OF THE INVENTION

Often electronic equipment, such as computer servers and audio equipment, is housed in cabinets to provide a safe and stable environment for the electronic equipment. However, since electronic equipment generates heat, most cabinets that hold critical electronic equipment provide some form of ventilation. For example, computer equipment and high end audio equipment generate significant heat. If those components are stored in a cabinet that restricts the air flow around the component, the heat will build up and could cause catastrophic failure of the component. In order to dissipate the heat, many cabinets are designed with completely open fronts or backs so that the air inside can vent to the atmosphere.

It is also not uncommon for hot spots to form at or near electronic equipment. These are zones where the heat builds up because, even though there may be openings in the cabinet or rack, the air flow around the electrical equipment is not sufficient to draw or force the air to move sufficiently to dissipate. In such situations, it is known to incorporate fans on the rack to either draw or force air through the rack, thus creating a desirable air flow in the rack and cooling the electronic equipment.

The heat buildup around electrical equipment is further increased by the development or buildup of dust or dirt on the electrical equipment. Dust tends to acts like insulation when it surrounds parts in electrical equipment or blocks equipment grills. When fans are incorporated into a cabinet to force air to flow inside, the fans are apt to draw additional dust or dirt into the cabinet. To remedy this, filters can be added to the fan to capture the particles which would otherwise be harmful to the electronic equipment. As the filter captures dust and dirt particles it slowly begins to clog, reducing airflow through the filter. If the filter clogs too much, it can lead to the airflow into the rack essentially stopping.

In order to prevent this from occurring, the current procedure is to periodically replace the filter to insure sufficient air flow to cool the electronic equipment. However, since it is not readily known when a filter is clogged, the periodic replacement may result in filters getting replaced when they are still useful, i.e., they still permit sufficient airflow to cool. This is particularly so since the number of particles that are filtered may change significantly over the course of a year. For example nearby construction or spring pollen may necessitate more frequent filter servicing. Since the cost of replacement filters and the cost of having a person service the filter can be high, an improvement filtration system is needed.

### BRIEF SUMMARY OF THE INVENTION

A smart air filter monitoring system for a cabinet for electronic devices is provided comprising: a filter support frame adapted to be mounted to or in a cabinet; an air filter removably mounted to the filter support frame, the filter having filter media positioned in an air flow within the cabinet so that at least a portion of the air flow in the cabinet passes through the filter media, the filter media having a first side and a second side, the air passing from the first side through the filter media to the second side; two light emitting devices located adjacent to the air filter, each light emitting device located on a side of the filter media; two sensors mounted near the filter for receiving light emitted by the light emitting devices, each sensor located on a side of the air filter and directed toward a different one of the two light emitting devices, the sensors adapted to generate electrical signals from the emitted light striking the light sensor; and a controller electrically connected to the sensors and adapted to receive the signals from the light sensors, the controller configured to provide a signal for indicating that the filter needs to be serviced when the controller determines that the electrical signals received from the sensors pass a threshold value.

In one aspect of the invention a smart air filter monitoring system for a cabinet for electronic devices is provided that includes: an air filter positioned in an air flow so that a significant amount of the air flowing in the cabinet is directed through the filter. Two light emitting devices are mounted adjacent or near the filter, preferably on the same side of the filter. Two light sensors are mounted on the opposite side of the air filter from the light emitting devices, each sensor directed toward a different one of the two light emitting devices. The sensors each generate an electrical signal representing the emitted light striking the light sensor. A monitoring device, such as an electrical circuit, monitors the signals received from the light sensors and provides a signal for indicating that the filter needs to be serviced when the monitoring device determines that electrical signals received from the sensors reach or pass a threshold. In other aspects of the invention, systems and methods are provided for determining when to service an air filter for a cabinet for electronic equipment.

### BRIEF DESCRIPTION OF THE DRAWINGS

For the purpose of illustrating the invention there is shown in the drawings various forms which are presently preferred; it being understood, however, that this invention is not limited to the precise arrangements and instrumentalities particularly shown.

FIG. 1 is an example of an embodiment of the present invention for a system for smart air filter monitoring.

FIGS. 2A and 2B are schematic illustrations of an example of an embodiment of a smart air filter monitoring system 100 according to an embodiment of the present invention where the system includes a normal air flow configuration and a bypass configuration.

FIGS. 3A and 3B are schematic illustrations of an example of an embodiment of a smart air filter monitoring system 100 where the system includes a normal air flow configuration and a bypass configuration.

FIG. 3C is a schematic illustration of an example of an embodiment of a smart air filter monitoring system where the system is in a bypass configuration.

FIGS. 4A and 4B are schematic illustrations of another example of an embodiment of a smart air filter monitoring system 100 according to an embodiment of the present invention where the system includes a normal air flow configuration and a bypass configuration.

FIG. 5 is a schematic illustration of an embodiment of a mounting arrangement for the filter in a smart air filter monitoring system 100 and includes a magnet for holding the filter in the normal air flow configuration.

FIG. 6 is a schematic illustration of an example of an embodiment of a controller of a smart air filter monitoring system 100 according to an embodiment of the present invention.

### DETAILED DESCRIPTION

Turning now to the Figures, various example methods, systems and transformers for methods and systems for smart air filter monitoring in accordance with the present invention will be described.

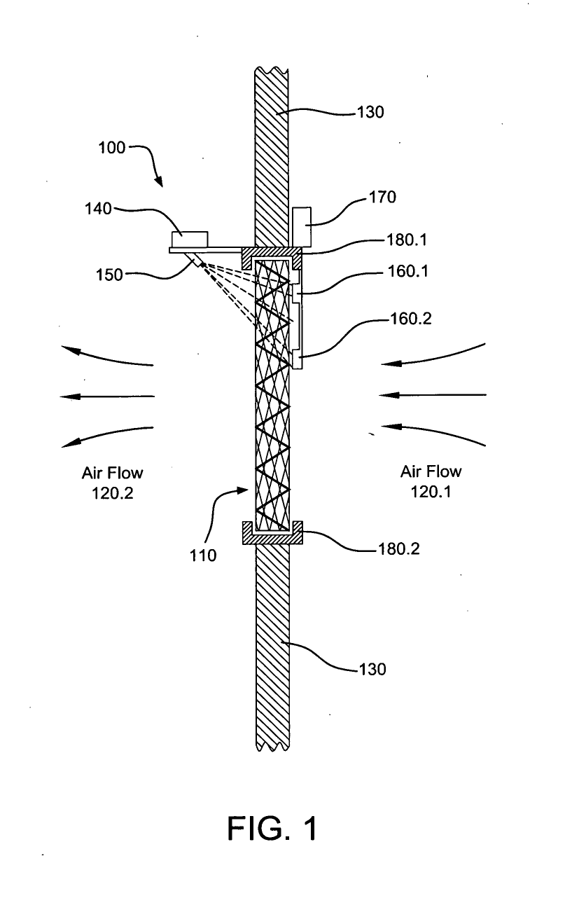

FIG. 1 is a schematic illustration of an example of an embodiment of a smart air filter monitoring system 100 according to an embodiment of the present invention. In the embodiment, a portion of an air flow 120 passes through an air filter 110 from outside a cabinet 130 to inside a cabinet 130. The smart air filter monitoring system 100 monitors the air filter 110 using the electrical signals generated by at least two light sensors 160, and when the air filter 110 needs to be serviced, provides a signal, which may be to a remote device, for turning on an indicator mechanism 170 which may be adjacent or remote from the sensors. The system for smart air filter monitoring 100 includes an air filter 110, a controller 140, a light emitting device 150, two light sensors 160, an indicator mechanism 170, which may be a light, and a filter support frame 180.

The materials that may be used for the filter support frame include, but are not limited to, a metal such as aluminum, an alloy, and plastic. In an embodiment, the filter support frame 180 attaches to the cabinet 130. The filter support frame 180 provides support for the air filter 110. Preferably, the air filter 110 is removable from the filter support frame 180. The filter support frame 180 may also provide support for other components which may include: the controller 140, the light emitting device 150, two light sensors 160, and an indicator mechanism 170. The air filter support frame 180 may include multiple parts. For example, brackets 180.1 and 180.2 may not be connected to one another.

The air filter 110 removes solid particulates from the air flow 120 and may be removed from the filter support frame 180. The materials that may be used for the air filter 110 include, but are not limited to, foam, pleated paper, spun fiberglass filter elements, and elements with a static electric charge, which attract dust particles.

In one embodiment, the controller 140 is an electrical circuit for controlling the operation of the system 100 and may be electrically connected to the two light sensors 160 and the indicator mechanism 150. In this embodiment, the controller 140 is electrically connected to the light emitting device 150. The controller 140 is preferably configured to provide a signal for turning on an indicator mechanism 170 and/or for notifying a remote device when the air filter 110 needs to be serviced.

The light emitting device 150 is preferably a light emitting diode (LED) that emits light, although the light emitting device could also be any other conventional light source, and could be ambient light. The light emitting device 150 is directed at the air filter 110 so that the light from the light emitting device 150 passes through the air filter 110 and strikes at least one light sensor 160. The light emitting device 150 is supported by the filter support frame 180. Alternating, the light emitting device 150 may be attached to the cabinet 130.

The at least two light sensors 160 are preferably photo detectors that generate electrical signals from receiving the light emitted by the light emitting device 150. In certain embodiments, two light emitting devices 150 rather than one light emitting device may be used and each directed to one of the sensors. The position of the light emitting device(s) 150 and the light sensors 160 relative to the air filter 110 may be switched. Additionally, many other positions of the light sensors 160 and/or the light emitting devices 150 are possible. The light sensors 160 are positioned to generate signals indicating how dirty two different areas of the air filter are. The light emitting device(s) 150 are positioned to emit light through the air filer 110 to strike the light sensors 160. The light emitting device(s) 150 and the light sensors 160 are mounted so as to preferably minimize interference with the air flow. Some of the places the light emitting device(s) and the light sensors 160 may be mounted include, but are not limited to, the cabinet 130, the air filter 110, the controller 140, and the filter support frame 180.

The indicator mechanism 160 is preferably an LED light electrically coupled to the controller 130. The cabinet 130 may be for housing electronic devices such as network computer servers, network routers/bridges, or audio equipment.

In operation, the air filter 110 is positioned in an airflow 120. The air filter 110 removes particulates from the airflow 120 and slowly begins to become clogged or dirty as the particulates accumulate in the air filter 110. The light emitting device(s) 150 emits light that passes through the air filter 110 and strikes the light sensors 160. The light sensors 160 generate electrical signals from the emitted light. The controller 140 receives the electrical signals and, based on the electrical signals, calculates whether or not the air filter 110 should be replaced. The more solid particulates filtered out of the airflow 120 by the air filter 110 the more the air filter 110 will block the light emitted from the light emitting device 150 from striking the light sensors 160, and, consequently, the weaker the electrical signals generated by the light sensors 160. When the controller 140 determines, based on the electrical signals from the light sensors 160, that the filter 110 needs service, the controller 130 provides a signal that turns on the indicator mechanism 170. The indicator mechanism 170 informs a person that the filter 110 needs service. The controller 130 may provide a signal to a remote device (not illustrated) to notify the remote device that the filter 110 needs service. In one embodiment, the controller 140 determines that the air filter 110 needs service when the average of the electrical signals drop to a pre-determined level. In another embodiment, the controller 140 determines that the air filter 110 needs service when one of the electrical signals drop to a pre-determined level. In another embodiment, the controller 140 determines that the air filter 110 needs service when both of the signals drop below a pre-determined level.

Once the air filter 110 is serviced the signals from the light sensors 160 return to a level that indicate that the air filter 110 no longer needs servicing and the controller 130 stops signaling that the air filter 110 needs to be serviced. The smart air filter monitoring system 100 may include a reset switch (not illustrated) for resetting or calibrating the smart air filter monitoring system 100.

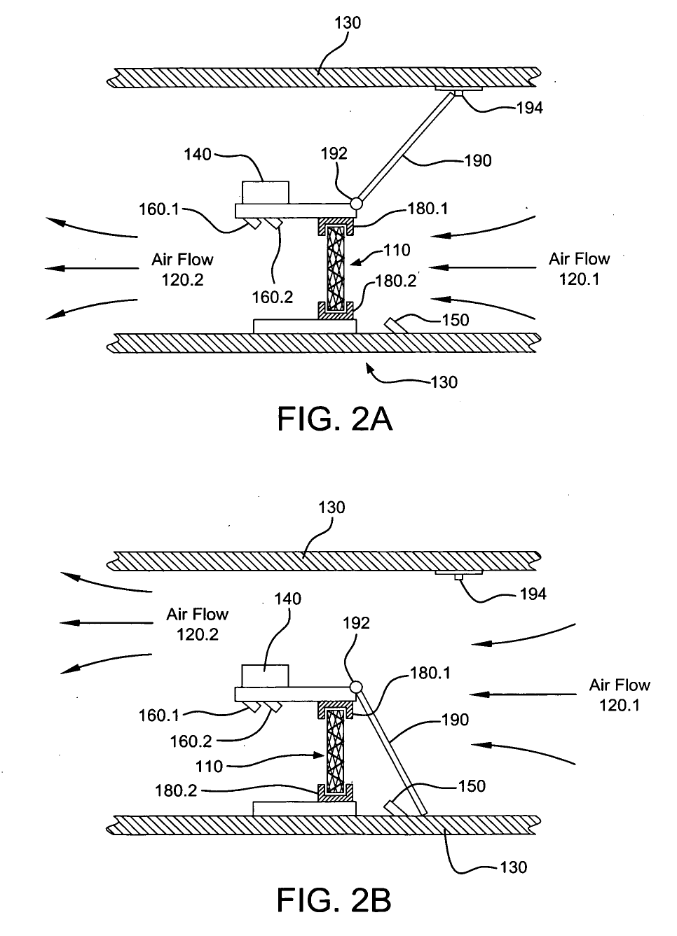

FIGS. 2A and 2B are schematic illustrations of an example of an embodiment of a smart air filter monitoring system 100 according to an embodiment of the present invention where the system includes a normal air flow configuration FIG. 2A and a bypass configuration FIG. 2B. The smart air filter monitoring system 100 monitors the air filter 120 in a normal air flow configuration FIG. 2A and when the air filter 110 is determined to be too clogged or dirty to continue to filter the air flow 120.1, the smart air filter monitoring system 100 changes the configuration to a bypass configuration FIG. 2B. FIG. 2A illustrates an example of a normal air flow configuration where a portion of an air flow 120.1 passes through an air filter 110 to an airflow 120.2 on the other side of the air filter 110. FIG. 2B illustrates an example of a bypass configuration where a portion of an airflow 120.1 passes by an air filter 110 to an airflow 120.2 without passing through the air filter 110.

The system for smart air filter monitoring 100 includes an air filter 110, a controller 140, a light emitting device 150, at least two light sensors 160, an indicator mechanism 170, a filter support frame 180. Additionally, the system for smart air filter monitoring 100 may include a door 190, a hinge 192 and a latch 194.

The door 190 may be constructed of a material suitable for blocking the air flow 120.1 such as aluminum or an alloy or plastic. The door 190 may be mounted with a hinge 192 and held in place with a latch 194. The hinge 192 may include a spring (not illustrated) for biasing the door 190 in the open position (FIG. 2B). The latch 194 may be electrically connected to the controller 140. The latch 194 may be configured to release the door 192 when the latch 194 receives a signal from the controller 140. The latch 194 may be implemented in a number of ways including an electromagnet, a mechanical latch 194 with an actuator, or with a shape memory alloy which may be called smart metal, memory alloy, or muscle wire.

The controller 140 is preferably configured to receive the signals generated by the light sensors 160 and, when the controller 140 determines that the system should be switched to the bypass configuration FIG. 2B, the controller 140 provides a signal to the latch 194. The latch 194 releases the door 190 which may be spring biased to a position corresponding to the bypass configuration FIG. 2B. In certain embodiments, the controller 140 may provide a signal to an actuator (not illustrated) to move the door 190 to the bypass configuration FIG. 2B position.

It is also contemplated that the smart air filter monitoring system 100 may not include a light emitting device 150. Instead, the light sensors 160 generate electrical signals from the ambient light that passes through the air filter 110. The controller 140 may be configured to determine when the air filter 110 needs to be serviced by adjusting for different ambient light conditions by calibrating for the amount of the light that strikes the light sensors 160 when the air filter 110 is installed (a clean state).

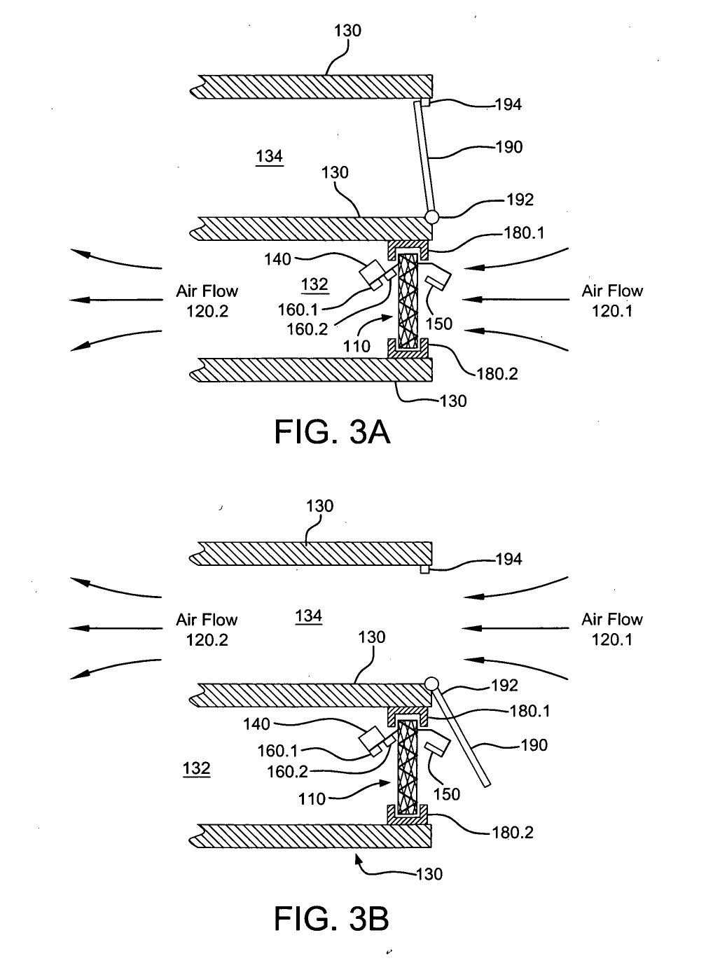

FIGS. 3A and 3B are schematic illustrations of an example of an embodiment of a smart air filter monitoring system 100 where the system includes a normal air flow configuration FIG. 3A and a bypass configuration FIG. 3B. FIGS. 3A and 3B illustrate that the airflow 120 may pass through a different opening 134 of the cabinet when in the bypass configuration FIG. 3B compared with the opening 132 of the cabinet when in the normal air flow configuration FIG. 3A.

FIG. 3C is a schematic illustration of an example of an embodiment of a smart air filter monitoring system 100 where the system is in a bypass configuration. In FIG. 3C the opening 134 for the bypass airflow 120.3, 120.4 is some distance from the opening 132 for the normal air flow 120.1, 120.2. As illustrated in FIG. 3C, the openings 132 and 134 are far enough apart so that the door 190 does not obstruct the opening 132 in the bypass configuration FIG. 3C. It is contemplated that the door 190 may partially obstruct the opening 132.

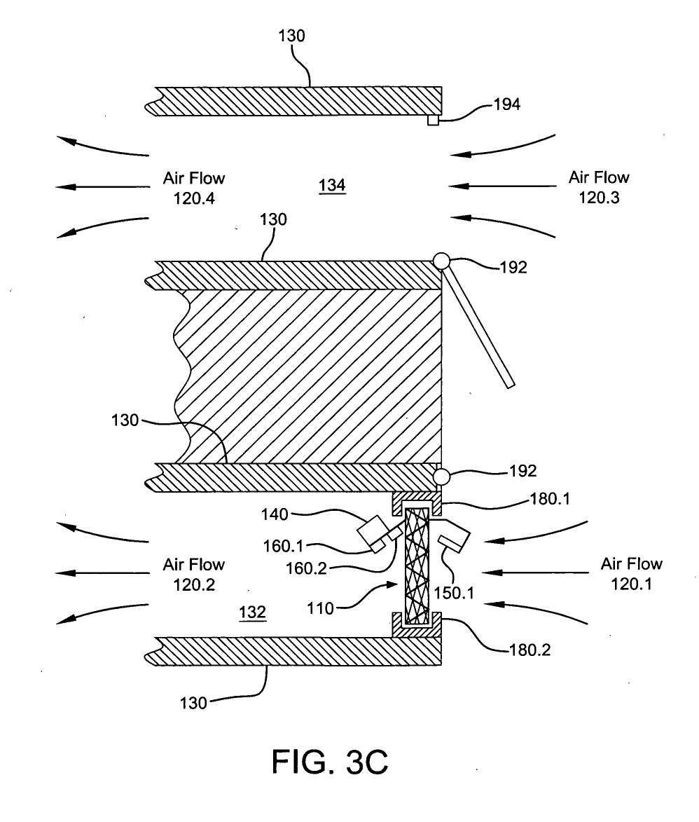

FIGS. 4A and 4B are schematic illustrations of an example of an embodiment of a smart air filter monitoring system 100 according to an embodiment of the present invention where the system includes a normal air flow configuration FIG. 4A and a bypass configuration FIG. 4B. The smart air filter monitoring system 100 monitors the air filter 110 in a normal air flow configuration FIG. 4A and, when the air filter 110 is determined to be too clogged or dirty to continue to filter the air flow 120.1, the smart air filter monitoring system 100 changes the configuration to a bypass configuration FIG. 4B. FIG. 4A illustrates an example of a normal air flow configuration where a portion of an air flow 120.1 passes through an air filter 110 to an airflow 120.2 on the other side of the air filter 110. FIG. 3B illustrates an example of a bypass configuration where a portion of an airflow 120.1 passes by an air filter 110 to an airflow 120.2 without passing through the air filter 110.

The system for smart air filter monitoring 100 includes an air filter 110, a controller 140, two light emitting devices 150, at least two light sensors 160, an indicator mechanism 170, a filter support frame 180. Additionally, the system for smart air filter monitoring 100 may include a hinge 192 and a latch 194. Additionally and/or alternatively, the system may include a fan 198.

The two light emitting devices 150 may be positioned to emit light at two different light sensors 160 so that how clogged or dirty the air filter 110 is can be measured at two distinct locations of the air filter 110.

The fan 198 may be positioned in the air flow 120.2 for increasing the air flow 120. The fan 198 may be configured to receive a signal from the controller 140 and adjust the speed of the fan 198 based on the signal. The air filter 110 may be mounted to the filter support frame 180. The air filter 110 may move relative to at least a portion of the filter support frame 180.2. The filter support frame 180 may be attached to the cabinet 130 by a hinge 192. The hinge 192 may include a spring (not illustrated) to bias the support frame 180 to the bypass configuration FIG. 4B.

In this embodiment, the controller 140 is configured to receive the signals generated by the light sensors 160 and when the controller 140 determines that the system should be switched to the bypass configuration FIG. 4B, the controller 140 provides a signal to the latch 194. The latch 194 releases the support frame 180 which may be spring biased to a position corresponding to the bypass configuration FIG. 4B. The controller 140 may provide a signal to an actuator (not illustrated) to move the support frame 180 to the bypass configuration FIG. 4B position.

The controller 140 may be configured to generate a signal to vary the speed of the fan 198 as a function of how clogged or dirty the air filter 110, based on the signals generated from the light sensors 160.

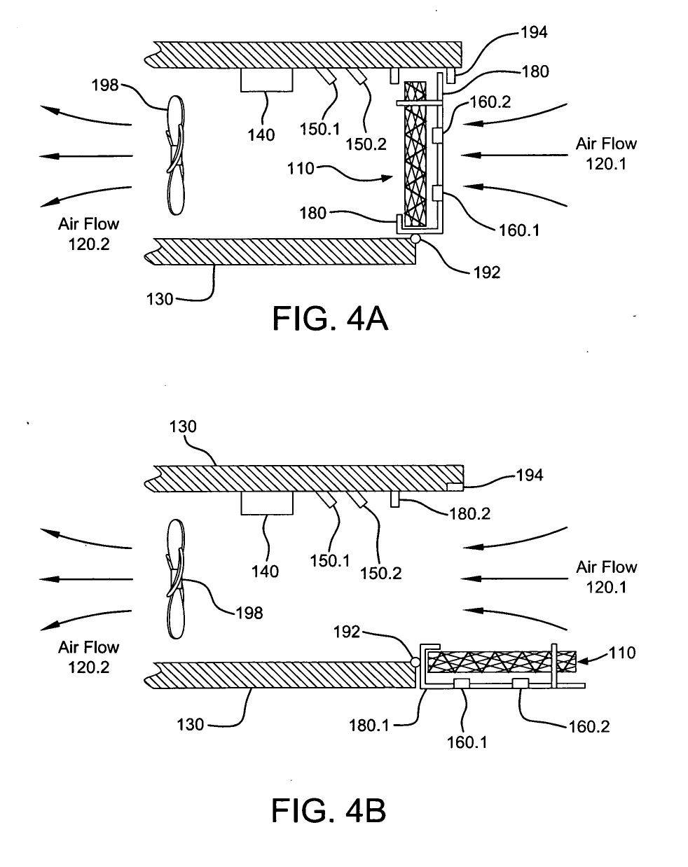

FIG. 5 is a schematic illustration of an example of an embodiment of a smart air filter monitoring system 100 where the system includes a normal air flow configuration and a bypass configuration and the air filter includes a magnet for holding the system in the normal air flow configuration.

The air filter 110 has a holding mechanism 195 positioned to be near the latch 194 when the system is in the normal air flow configuration. The holding mechanism 195 may be a number of different things including a magnet and a wire. The latch 194 may include a electromagnet. The latch 194 may turn off the electromagnet in response to a signal from the controller to switch the system to the bypass configuration (not illustrated.) The latch 194 may include a shape memory alloy. The latch 194 may be formed from shape memory alloy such that it has a first deformed shape that retrains the door from closing and a second non-deformed shape that permits the door to swing open or shut. The change from one shape to the other is effected by sending a signal from the controller to switch the system to the bypass configuration (not illustrated.) The system preferably includes light sensors, a controller, and light emitting device(s) as discussed above. For example, the air filter 110 may include two light sensors that are electrically connected to the controller at least when the system is in the normal air flow configuration. When the sensed signals indicate that the filter is clogged, the electromagnetic is deactivated, allowing the filter 110 to fall out of the opening into a bypass configuration. The filter preferably includes a frame that is hinged to the cabinet on an end opposite form the magnet.

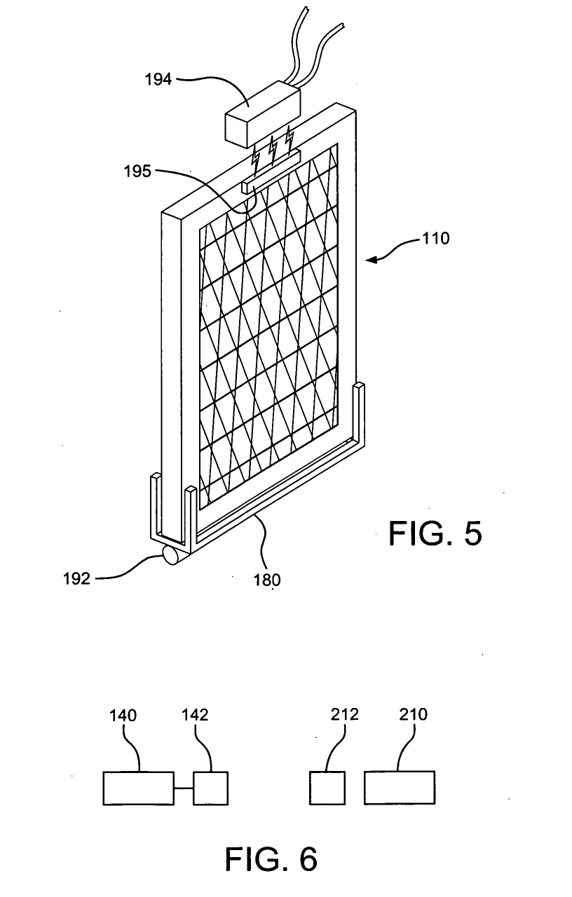

FIG. 6 is a schematic illustration of an example of another embodiment of a smart air filter monitoring system 100. The controller 140 may include a device 142 for communicating to a remote device 210 which may include a device 212 for communicating to the controller 140. The remote device 210 may be a computer. The remote device 210 may include a remote supervisory system which may be arranged to monitor the status of the filter and notify a technician when the filter needs to be serviced. The remote device 210 may be configured to display the status of the filter on a electronic monitor. Examples of devices 142, 212 that would be suitable for communicating with a computer include, but are not limited to, a wireless network card and a network cable. The controller 140 may be configured to receive and transmit signals to the computer 210. The controller 140 may communicate directly with the computer 210 or indirectly. For example, the controller 140 may communicate with a local router or computer that relays messages to the computer 210. The controller 140 may be configured to transmit information related to the state of the smart air filter monitoring system. For example, the signals received from the light sensors, the current speed of a fan, the current configuration of the system (bypass mode or normal air flow mode), or a calculated measure of how dirty or clogged the air filter is may be transmitted to the computer. And the controller 140 may be configured to receive commands from the computer 210. For example, the controller 140 may transmit to the computer 210 information related to the signals received from the light sensors and then receive a command to indicate that the air filter needs servicing or to switch the system to the bypass configuration. The controller may include an identifier that identifies the controller to a remote computer. The remote computer may generate notifications that the air filter needs servicing.

One advantage of the smart air filter monitoring system 100 is that by monitoring the state of the air filter 110 the air filter 110 does not have to be serviced unless the air filter 110 needs to be serviced. Because servicing an air filter 110 may be expensive, it is better not to service the air filter 110 unless the air filter 110 is truly in need of servicing.

Another advantage of embodiments of the smart air filter monitoring system 100 is that by using multiple light sensors 160 the system 100 can base the calculation of whether or not the air filter 110 needs to be serviced on more than one part of the air filter 110. This can be important because air filters 110 may have parts of the filter media with many particulates and other parts of the filter media may be relatively free of particulates. A single light sensor 160 signaling that the filter media is restricting air flow 120 may not be representative of the entire air filter 110. Specifically, it is preferable to take at least two readings, one preferably of the region of the filter media that generally receives a significant amount of particulates, such as in the valley of a pleated filter, and another region that is not in the same location, e.g., not the valley of a pleated filter but, instead at a location between the peak and the valley. The condition of the filter is then determined as a function of the two sensed readings.

The controller is preferably communicatively coupled instead of being electrically couple to the light sensors and/or the light emitting device and/or the indicator mechanism. For example, the controller may be in communication with the light sensors using a wireless protocol such as Bluetooth™.

The use of the terms “a” and “an” and “the” and similar referents in the context of describing the invention (especially in the context of the following claims) are to be construed to cover both the singular and the plural, unless otherwise indicated herein or clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various embodiments of this invention are described herein. However, it should be understood that the illustrated embodiments are exemplary only, and should not be taken as limiting the scope of the invention.

What is claimed is:

1. A smart air filter monitoring system for a cabinet for electronic devices comprising:
a filter support frame adapted to be mounted to or in a cabinet;
an air filter removably mounted to the filter support frame, the air filter having filter media positioned in an air flow within the cabinet so that at least a portion of the air flow in the cabinet passes through the filter media, the filter media having a first side and a second side, the air passing from the first side through the filter media to the second side;
a light emitting device located adjacent to the air filter and positioned to emit light toward the air filter;
at least two light sensors mounted near the air filter, each light sensor directed to the air filter to receive light emitted from the light emitting device after the emitted light has passed through the air filter, the light sensors adapted to generate electrical signals from the emitted light striking the light sensor; and
a controller electrically connected to the sensors and adapted to receive the signals from the light sensors, the controller configured to provide a signal for indicating that the filter needs to be serviced when the controller calculates that the electrical signals indicate that the air filter needs to be serviced.

2. The system of claim 1, including a first indicator light electrically connected to the controller and adapted to turn on an indicator visible outside the cabinet when the signal indicating that the filter needs to be serviced is received from the controller.

3. The system of claim 1, wherein the light emitting device is disposed substantially out of the air flow.

4. The system of claim 1, wherein the system includes a bypass configuration wherein at least a portion of the air flow is channeled so as not to pass through the filter media, and wherein the controller controls the channeling of the air flow from a normal air flow configuration where the portion of air flows through the filter media to the bypass configuration based on the electrical signals received from the light sensors.

5. The system of claim 4, wherein the air filter is movably mounted to the filter support frame so that it is movable from a first position relative to the filter support frame which corresponds to the normal air flow configuration and a second position relative to the filter support frame which corresponds to the bypass configuration, and wherein the controller is adapted to generate a signal for controlling movement of the air filter from the first position to the second position based on the electrical signals generated by the light sensors.

6. The system of claim 5, including a lock mechanism for holding the air filter in the first position, wherein the controller is configured to generate a signal to release the lock mechanism to move the air filter from the first position to the second position.

7. The system of claim 6, wherein the lock mechanism includes a latch that holds the air filter in the first position and the controller is configured to generate a signal to release the latch to move the air filter from the first position to the second position.

8. The system of claim 5, including a spring which biases the air filter in the second position.

9. The system of claim 5, including a shape memory alloy for holding the air filter in the first position, the controller configured to generate a signal to cause the shape memory alloy to release the air filter to move the air filter from the first position to the second position.

10. The system of claim 5, including an electromagnet for holding the air filter in the first position, the controller configured to generate a signal to turn the electromagnet off to move the air filter from the first position to the second position, the air filter including a magnet being adjacent to the electromagnet to hold the air filter in the first position.

11. The system of claim 4, wherein the system includes a bypass channel past the air filter and a door for obstructing the bypass channel in the normal air flow configuration, and wherein the controller is configured to control the movement of the door so as not to obstruct the bypass channel in the bypass configuration.

12. The system of claim 11, including a lock mechanism for holding the door for obstructing the bypass channel, wherein the controller is configured to generate a signal to release the lock mechanism to move the door so as not to obstruct the bypass channel in the bypass configuration.

13. The system of claim 5, including a second indicator light electrically connected to the controller, wherein the controller is adapted to generate a signal for the second indicator light to turn on an indicator visible outside the cabinet when the system is in the bypass configuration.

14. The system of claim 12, wherein the indicator of the first indicator light glows yellow when turned on and the indicator of the second indicator light glows red when turned on.

15. The system of claim 1, including a second light emitting device located adjacent to the air filter and positioned to emit light toward the air filter.

16. The system of claim 15, wherein the light emitting devices are mounted to direct light to different portions of the filter media so as to provide an indication of the dirt buildup at least two distinct locations of the air filter.

17. The system of claim 15, wherein the light emitting devices and the light sensors are mounted on the filter support frame.

18. The system of claim 15, wherein the light emitting devices are located on the same side of the air filter.

19. The system of claim 15, wherein the controller is adapted to calculate an average value based on the signals from the light sensors and to compare the average of the signals to a threshold to calculate if the air filter needs servicing.

20. The system of claim 15, wherein the controller is adapted to compare one signal to a first threshold value and at least one other signal to a second threshold value, the controller providing a first signal on the state of the air filter based on the first comparison and a second signal based on at least the second comparison, and the controller sends the signal that the air filter needs to be serviced after the first comparison and controls the flow past the filter media based on at least the second comparison.

21. The system of claim 1, wherein the controller is configured to generate a signal for indicating how dirty the air filter is based on the received signals, and wherein an indicator light is adapted to receive the generated signal from the controller and display how dirty the air filter is.

22. The system of claim 1, wherein the controller is configured to provide the signal for indicating that the filter needs to be serviced to a remote device.

23. The system of claim 1, wherein the controller is configured to provide the signal for indicating that the filter needs to be serviced to a remote supervisory system, wherein the remote supervisory system is configured to display how dirty the air filter is.

24. The system of claim 1, including a fan and wherein the controller is configured to generate a signal to set the speed of the fan based on the received signals.

25. The system of claim 15, wherein the light emitting devices are on different sides of the air filter, and wherein the light sensors are on different sides of the air filter.

26. A method for monitoring a smart air filter of a cabinet for electronic devices comprising:
emitting light by a light emitting device toward an air filter positioned in an air flow within a cabinet;
generating electrical signals in response to light striking at least two light sensors located adjacent to the air filter, the light sensors directed to the air filter to receive light emitted from the light emitting device after the emitted light has passed through the air filter;
in response to receiving the generated electrical signals, calculating whether the air filter needs to be serviced based on the generated electrical signals, and when the air filter needs to be serviced, providing a signal for indicating that the filter needs to be serviced.

27. The method of claim 26, including:
in response to receiving the signal for indicating that the filter needs to be serviced, indicating outside the cabinet that the filter needs to be serviced.

28. An air filter, including:
a holding mechanism located near an edge of the air filter for holding the air filter in position; and
filter medium for filtering particulates from an air flow.

29. The air filter of claim 28 wherein the holding mechanism is a magnet.

30. The air filter of claim 28, including a light emitting device for emitting light through the filter medium for use in determining when the air filter needs to be serviced.

31. The air filter of claim 28, including at least two light sensors, each light sensor directed to receive light emitted from a light emitting device after the emitted light has passed through the air filter, the light sensors adapted to generate electrical signals from the emitted light striking the light sensor, and the light sensors configured to be electrically connected to a controller when the air filter is installed.
